(19) United States
(12) Patent Application Publication
(10) Pub. No.: US 2026/0166988 A1
(43) Pub. Date: Jun. 18, 2026

(54) DISPLAY CONTROL DEVICE AND STORAGE MEDIUM

(71) Applicant: TOYOTA JIDOSHA KABUSHIKI KAISHA, Toyota-shi (JP)

(72) Inventors: Yushi MITSUYA, Nishio-shi (JP); Shota TOGAWA, Kariya-shi (JP)

(73) Assignee: TOYOTA JIDOSHA KABUSHIKI KAISHA, Toyota-shi (JP)

(21) Appl. No.: 19/307,541

(22) Filed: Aug. 22, 2025

(30) Foreign Application Priority Data
Dec. 12, 2024 (JP) 2024-218213

(51) Int. Cl. B60K 35/10; B60K 31/00; B60K 35/28; B60K 35/29

(52) U.S. Cl. CPC B60K 35/10; B60K 31/00; B60K 35/28; B60K 35/29; B60K 2360/167; B60K 2360/182

(57) ABSTRACT

When the crawl control function mounted on the vehicle changes from the non-operating state to the operating state, the display control device performs control of causing the display to transition from the first screen to the second screen indicating that the crawl control function is in the operating state and displaying the second screen on the display unit for a predetermined period of time, and after the display of the second screen ends, performs control of adding the set speed of the vehicle in the crawl control function to the first screen and displaying the same on the display unit.

### CROSS-REFERENCE TO RELATED APPLICATION

This application claims priority to Japanese Patent Application No. 2024-218213 filed on December 12, 2024. The disclosure of the above-identified application, including the specification, drawings, and claims, is incorporated by reference herein in its entirety.

### BACKGROUND

### 1. Technical Field

The present disclosure relates to a display control device and a storage medium.

### 2. Description of Related Art

Japanese Unexamined Patent Application Publication No. 2009-120059 (JP 2009-120059 A) describes a crawl control function as a driving support function of a vehicle.

### SUMMARY

However, there is room for improvement in terms of allowing an occupant of the vehicle to grasp a set speed of the vehicle set by the crawl control function in a state in which the crawl control function is operating.

The present disclosure has been made in view of the above circumstances, and an object of the present disclosure is to provide a display control device and a storage medium capable of allowing an occupant of a vehicle to grasp a set speed of the vehicle set by a crawl control function.

A first aspect provides a display control device including a display control unit configured to: when a crawl control function provided in a vehicle is turned from a non-operating state to an operating state, control a display unit so as to display a second screen for a predetermined period, the second screen transitioning from a first screen and indicating that the crawl control function is turned to the operating state; and control the display unit so as to additionally display a set speed of the vehicle set by the crawl control function on the first screen after display of the second screen is finished.

According to the display control device of the first aspect, when the crawl control function is turned from the non-operating state to the operating state, the second screen is displayed for a predetermined period, and after the display of the second screen is finished, the first screen is displayed with the addition of the set speed of the vehicle set by the crawl control function. Thus, the occupant of the vehicle can grasp the set speed of the vehicle set by the crawl control function.

The display control device of the second aspect is the display control device of the first aspect, in which the display control unit is configured to: when the crawl control function is turned from the non-operating state to the operating state, control the display unit so as to display the second screen by superimposing a display layer of the set speed of the vehicle set by the crawl control function and a display layer of the second screen on a display layer of the first screen; and control the display unit so as to additionally display the set speed of the vehicle set by the crawl control function on the first screen by deleting the display layer of the second screen after the predetermined period has elapsed since control for displaying the second screen is performed.

According to the display control device of the second aspect, the first screen is displayed with the addition of the set speed of the vehicle set by the crawl control function, by deleting the display layer of the second screen. Thus, the occupant of the vehicle can grasp the set speed of the vehicle set by the crawl control function through a simple drawing process.

The display control device of the third aspect is the display control device of the second aspect, in which the display control unit may delete the display layer of the set speed of the vehicle set by the crawl control function when an input of a switch operation to turn the crawl control function to the non-operating state is received.

According to the display control device of the third aspect, the display layer of the set speed of the vehicle set by the crawl control function is deleted when an input of a switch operation to turn the crawl control function to the non-operating state is received. Thus, the occupant of the vehicle can return to the normal screen display through a simple operation.

A storage medium of a fourth aspect stores a display control program causing a computer to execute a process including: when a crawl control function provided in a vehicle is turned from a non-operating state to an operating state, controlling a display unit so as to display a second screen for a predetermined period, the second screen transitioning from a first screen and indicating that the crawl control function is turned to the operating state; and controlling the display unit so as to additionally display a set speed of the vehicle set by the crawl control function on the first screen after display of the second screen is finished.

According to the present disclosure, the occupant of the vehicle can grasp the set speed of the vehicle set by the crawl control function.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing a state in which a front portion of a vehicle cabin is viewed from a vehicle rear side;

FIG. 2 is a block diagram illustrating an example of a hardware configuration of a display control device;

FIG. 3 is a block diagram illustrating an example of a functional configuration of a display control device;

FIG. 4 is a diagram illustrating an example of a first screen;

FIG. 5 is a diagram for explaining a display method of the second screen;

FIG. 6 is a diagram illustrating an example of a second screen;

FIG. 7 is a diagram illustrating an exemplary third window; and.

FIG. 8 is a flowchart illustrating an example of a display control process.

### DETAILED DESCRIPTION OF EMBODIMENTS

Hereinafter, examples of an embodiment for carrying out the disclosure will be described in detail with reference to the drawings.

Although the driving support functions included in the vehicle 12 of the present embodiment include various driving support functions, the following driving support functions will be described as an example in the present embodiment.

(1) Crawl control (CRAWL Control). This function is a function of providing the following support only by operating the steering wheel without the driver operating the accelerator pedal and the brake pedal. This function is a function of assisting a vehicle to travel on a bad road such as an off-road having relatively large irregularities, a slippery road surface, and a steep slope while maintaining a very low speed. In this specification, the function is referred to as a "crawl control function".

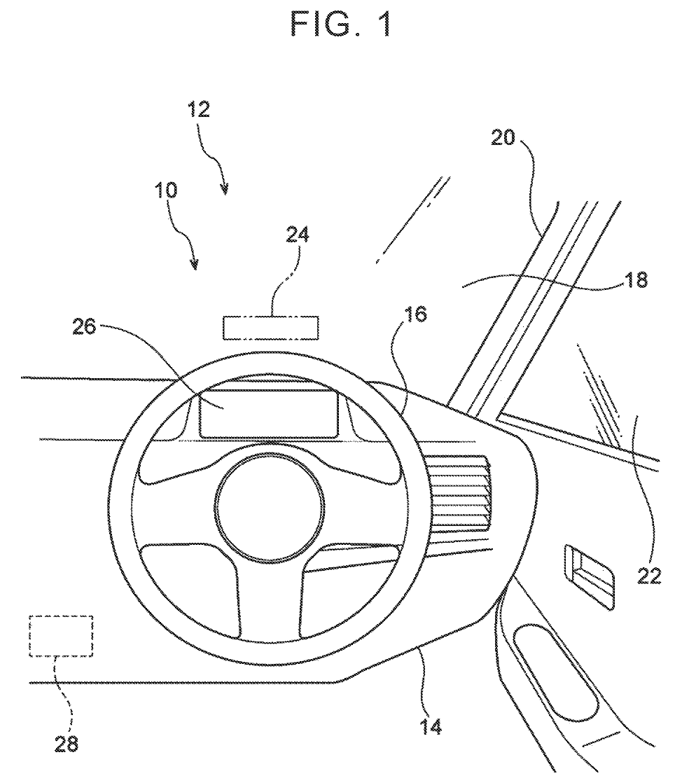

First, a configuration of the vehicle 12 to which the display control device 10 according to the present embodiment is applied will be described with reference to FIG. 1. As shown in FIG. 1, an instrument panel 14 is provided at a front portion of the vehicle 12 in the vehicle cabin. The instrument panel 14 extends in the vehicle width direction, and a steering wheel 16 is provided on the vehicle right side of the instrument panel 14. That is, in the present embodiment, the steering wheel 16 is provided on the right side, and the driver's seat is set on the right side of the vehicle, for example.

A windshield glass 18 is provided at a front end portion of the instrument panel 14. The windshield glass 18 extends in the vehicle vertical direction and the vehicle width direction and partitions the interior and the exterior of the vehicle cabin.

The vehicle right end portion of the windshield glass 18 is fixed to the front pillar 20 on the vehicle right side. The front pillar 20 extends in the vehicle vertical direction, and a windshield glass 18 is fixed to an inner end portion of the front pillar 20 in the vehicle width direction. Further, a front end portion of the front side glass 22 is fixed to an outer end portion of the front pillar 20 in the vehicle width direction. The vehicle left end portion of the windshield glass 18 is fixed to a front pillar on the left side of the vehicle (not shown).

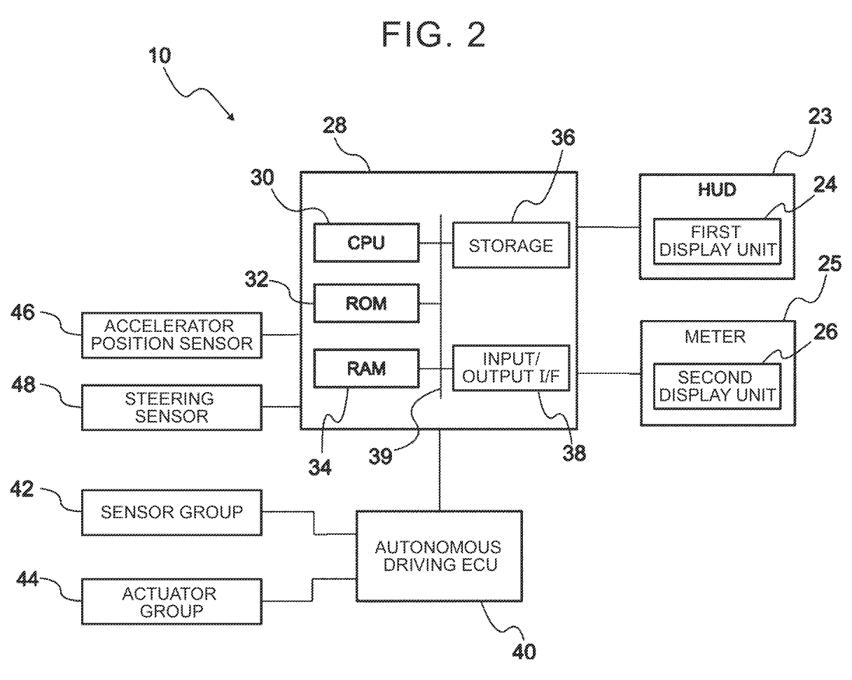

The windshield glass 18 is provided with a first display unit 24. The first display unit 24 is constituted by a projection surface projected by a head-up display device 23 (see FIG. 2; in FIG. 2, "HUD" (Head Up Display)). Specifically, the head-up display device 23 is provided on the vehicle front side of the instrument panel 14. Further, the image is projected from the head-up display device 23 toward the first display unit 24 of the windshield glass 18.

A second display unit 26 is provided on the vehicle lower side of the first display unit 24. The second display unit 26 is a display unit displayed on the meter 25 (see FIG. 2), and the meter 25 is located in front of the vehicle of the driver's seat in the instrument panel 14. The first display unit 24 and the second display unit 26 are provided at positions visible to the driver. The second display unit 26 is an example of a display unit according to the disclosed technology.

A hardware configuration of the display control device 10 will be described with reference to FIG. 2. The display control device 10 is a device that controls display on the second display unit 26. As shown in FIG. 2, the display control device 10 includes an ECU (Electronic Control Unit) 28. ECU 28 is an exemplary computer.

ECU 28 includes CPU (Central Processing Unit) 30, ROM (Read Only Memory) 32. ECU 28 also includes RAM (Random Access Memory) 34, storages 36 and input/output I/F (Interface) 38. CPU 30, ROM 32, RAM 34, the storage 36, and the input/output I/F 38 are communicably connected to each other via an internal bus 39.

CPU 30 is a central processing unit that executes various programs and controls each unit. That is, CPU 30 reads the program from ROM 32 or the storage 36, and executes the program using RAM 34 as a working area. In addition, CPU 30 performs control of the above-described configurations and various arithmetic processes in accordance with programs recorded in ROM 32 or the storage 36.

ROM 32 stores various programs and various data. RAM 34 temporarily stores a program/data as a working area. The storage 36 is constituted by HDD (Hard Disk Drive), SSD (Solid State Drive), or flash memory. The storage 36 is a non-transitory recording medium that stores various programs including an operating system and various data. In this embodiment, ROM 32 or the storage 36 stores a display control program or the like for performing a display control process. Various input/output devices are connected to the input/output I/F 38.

ECU 28 is electrically connected to the autonomous driving ECU 40. The autonomous driving ECU 40, like ECU 28, includes a CPU, ROM, RAM (not shown), a storage/input/output I/F, and the like.

The autonomous driving ECU 40 is connected with a sensor group 42 for detecting the present condition of the vehicle 12 and an actuator group 44 for controlling the travel of the vehicle 12. The sensor group 42 includes various sensors such as a camera and a radar. The sensor group 42 includes various sensors such as a lidar (LIDAR; Light Detection and Ranging or Laser Imaging Detection and Ranging) sensor and a GPS (Global Positioning System) sensor. The camera captures an image of the surroundings of the vehicle 12. The radar detects a distance and a direction from an object in the vicinity of the vehicle 12 by radio waves. The lidar detects a distance and a direction from an object in the vicinity of the vehicle 12 by the laser beam. GPS sensor detects the present position of the vehicle 12.

The actuator group 44 includes an acceleration/deceleration actuator for adjusting acceleration/deceleration of the vehicle 12 and a steering actuator for driving a steering device of the vehicle 12. The autonomous driving ECU 40 performs autonomous driving of the vehicle 12 by controlling the operation of the actuator group 44 according to the present condition of the vehicle 12 detected by the sensor group 42. The storage unit of the autonomous driving ECU 40 stores a scheduled route representing a route on which the vehicle 12 is scheduled to travel, and the autonomous driving ECU 40 causes the vehicle 12 to travel along the scheduled route stored in the storage unit.

An accelerator position sensor 46 and a steering sensor 48 are connected to ECU 28. The accelerator position sensor 46 is a sensor for detecting a position of an accelerator pedal (not shown) provided at a lower portion of the driver's seat. The steering sensor 48 is a sensor that detects a load applied to the steering wheel 16 by an occupant.

Incidentally, the vehicle 12 according to the present embodiment is equipped with the crawl control function described above. For example, the crawl control function is activated when all of the following conditions (1) to (5) are satisfied. The conditions under which the crawl control function is activated are not limited to the conditions (1) to (5).

(1) The switch for switching the crawl control function on and off is turned on.

(2) The engine is running.

(3) The position of the shift lever is not either the parking position or the neutral position.

(4) The transfer switch is on the low-speed side.

(5) The driver's door is closed.

In the vehicle 12 according to the present embodiment, the set speed of the vehicle 12 can be set within a predetermined range in an operating state in which the crawl control function is activated. When the crawl control function is in an activated state, the vehicle 12 travels while maintaining the set speed.

In the vehicle 12 according to the present embodiment, when the crawl control function changes from the non-operating state to the operating state, information indicating that the crawl control function has become the operating state (hereinafter, referred to as "operating information") is outputted from the autonomous driving ECU 40 to ECU 28. Further, in the vehicle 12 according to the present embodiment, when the crawl control function is in the operating state and the switch for switching on and off of the crawl control function is switched off, the crawl control function is in the non-operating state. Here, information indicating that the crawl control function is deactivated (hereinafter, referred to as "deactivation information") is outputted from the autonomous driving ECU 40 to ECU 28. In other words, when the crawl control function is deactivated by the occupant of the vehicle 12, the deactivation information is outputted from the autonomous driving ECU 40 to ECU 28.

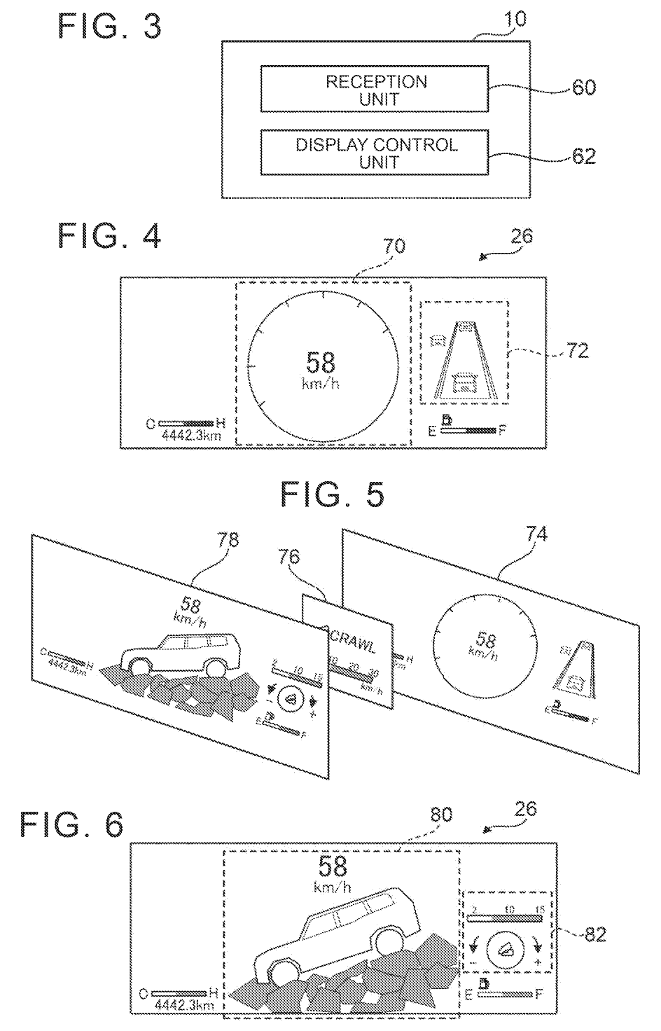

A functional configuration of the display control device 10 according to the present embodiment will be described with reference to FIG. 3. As illustrated in FIG. 3, the display control device 10 includes a reception unit 60 and a display control unit 62. CPU 30 executes the display control program stored in ROM 32 or the storage 36, thereby functioning as the reception unit 60 and the display control unit 62.

The reception unit 60 receives operation data outputted from the autonomous driving ECU 40. The reception unit 60 receives the deactivation data outputted from the autonomous driving ECU 40.

When the crawl control function is in the inactive state, the display control unit 62 performs control to display the first screen on the second display unit 26 as an example of the display unit. FIG. 4 illustrates an example of the first screen. As shown in FIG. 4, the first screen includes a display area 70 in which the current speed of the vehicle 12 is displayed. The first screen includes an image that mimics the vehicle 12 and an image that mimics a road surface of a traveling lane that is a lane on which the vehicle 12 travels. The first screen also includes a display area 72 in which conditions around the vehicle 12 are displayed, such as an image simulating a preceding vehicle traveling in front of the vehicle 12 and an image simulating a vehicle traveling in an adjacent lane adjacent to the traveling lane. The first screen is a normal display screen displayed when the driver of the vehicle 12 is performing manual driving.

When the reception unit 60 receives the operation information, the display control unit 62 performs control to display the second screen on the second display unit 26 for a predetermined period (for example, 6 seconds) by causing the display to transition from the first screen to the second screen indicating that the crawl control function is in the operation state. Then, after the display of the second screen is finished, the display control unit 62 performs control to add the set speed of the vehicle 12 in the crawl control function to the first screen and display it on the second display unit 26. The case in which the reception unit 60 receives the operation information means a case in which the crawl control function changes from the non-operation state to the operation state.

As an example, as illustrated in FIG. 5, the display control unit 62 overlays the display layer 76 of the setting speed of the vehicle 12 in the crawl control function and the display layer 78 of the second screen on the display layer 74 of the first screen. Thus, the display control unit 62 performs control to display the second screen on the second display unit 26. As illustrated in FIG. 5, in the display layer 76, a character string indicating that the vehicle is under crawl control and a set speed of the vehicle 12 in the crawl control function are displayed. Further, in the present embodiment, the display control unit 62 performs control to display the second screen by superimposing the display layer 76 on the display layer 74 and superimposing the display layer 78 on the display layer 76. Accordingly, since the display layer 74 and the display layer 76 are hidden behind the display layer 78, the second screen is displayed on the second display unit 26.

FIG. 6 illustrates an example of the second screen. As illustrated in FIG. 6, the second screen includes a display area 80 in which an effect indicating that the vehicle 12 is traveling off-road is displayed, and a display area 82 in which a set speed of the vehicle 12 in the crawl control function is displayed. In addition, the display area 82 further displays an image indicating that the set speed can be increased or decreased by turning a dial for adjusting the set speed of the vehicle 12 in the crawl control function.

Then, the display control unit 62 deletes the display layer 78 of the second screen after a predetermined period of time has elapsed since the control for displaying the second screen is performed. By doing so, control is performed to add the set speed of the vehicle 12 in the crawl control function to the first screen and display it on the second display unit 26. That is, the second screen is a screen temporarily displayed on the second display unit 26 as an effect indicating that the crawl control function is in the operating state.

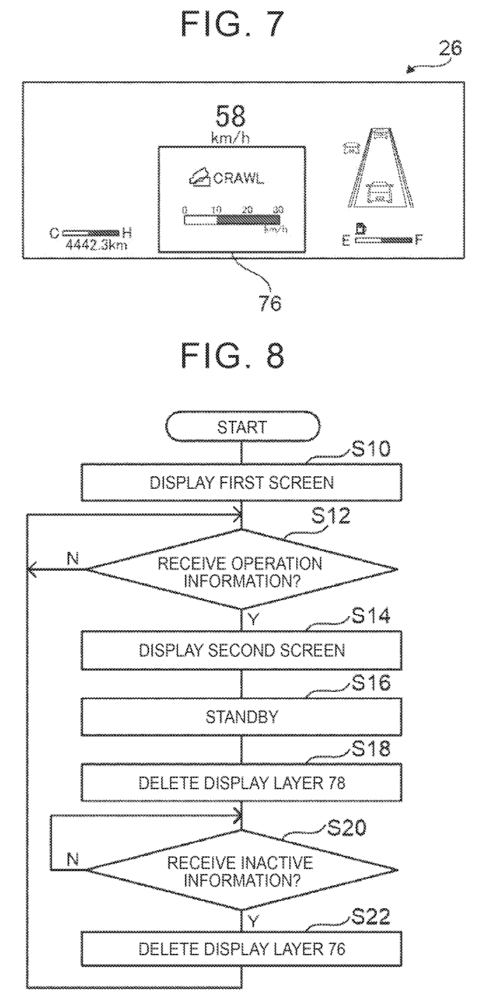

FIG. 7 shows an example of a third screen in which the set speed of the vehicle 12 in the crawl control function is added to the first screen. As illustrated in FIG. 7, in the third screen according to the present embodiment, the display layer 76 is superimposed on the display layer 74, so that the set speed of the vehicle 12 in the crawl control function is displayed in addition to the first screen. For example, in a case where the display layer 76 does not exist, and transition from the first screen to the second screen is temporarily performed and the display returns to the first screen, the occupant of the vehicle 12 can grasp the set speed of the vehicle 12 in the crawl control function only within the display period of the second screen. In this case, when the crawl control function is deactivated after the state in which the crawl control function is activated continues, the occupant of the vehicle 12 does not know the set speed. Therefore, the occupant of the vehicle 12 does not know the degree of variation in the speed of the vehicle 12 when the crawl control function such as how much deceleration occurs is released. On the other hand, in the present embodiment, the occupant of the vehicle 12 can continue to grasp the set speed of the vehicle 12 in the crawl control function even during the operation of the crawl control function.

In addition, the display control unit 62 deletes the display layer 76 when the reception unit 60 receives the non-operation information. Thus, the screen displayed on the second display unit 26 returns to the first screen. The case in which the reception unit 60 receives the non-operation information means a case in which an input for setting the crawl control function to the non-operation state is received by the switch operation.

The operation of the display control device 10 according to the present embodiment will be described with reference to FIG. 8. The display control process illustrated in FIG. 8 is executed by CPU 30 executing a display control program stored in ROM 32 or the storage 36. The display control process is executed when the ignition switch of the vehicle 12 is turned on. In the present embodiment, a case where the crawl control function is in a non-operating state at the start of the display control processing will be described as an example.

In S10 of FIG. 8, the display control unit 62 performs control of displaying the first screen on the second display unit 26. In S12, the reception unit 60 stands by until the operation data outputted from the autonomous driving ECU 40 is received. When the crawl control function changes from the non-operating state to the operating state, the determination of S12 is affirmative, and the process proceeds to S14.

In S14, as described above, the display control unit 62 performs control to display the second screen on the second display unit 26 by causing the display to change from the first screen to the second screen indicating that the crawl control function has been activated. In S16, the display control unit 62 waits for a predetermined time. When the predetermined time elapses after the second screen is displayed on S14, the process proceeds to S18. In S18, the display control unit 62 performs control of deleting the display layer 78 of the second screen, adding the set velocity of the vehicles 12 in the crawl control function to the first screen, and displaying the same on the second display unit 26.

In S20, the reception unit 60 waits until the deactivation data outputted from the autonomous driving ECU 40 is received. When the crawl control function is deactivated by switching, the determination of S20 is affirmative, and the process proceeds to S22. In S22, the display control unit 62 deletes the display layer 76. When S22 process ends, the process returns to S12.

As described above, according to the present embodiment, the set speed of the vehicle 12 in the crawl control function is displayed even after the second screen is temporarily displayed. Therefore, even when the crawl control function continues to operate, the occupant of the vehicle 12 can grasp the set speed of the vehicle 12 in the crawl control function.

In the above-described embodiment, the display control unit 62 may superimpose the display layer 76 on the display layer 74 when the setting speed of the vehicle 12 in the crawl control function is changed by a dial operation. Thus, the display control unit 62 may perform control to display the first screen by adding the set speed of the vehicle 12 in the crawl control function.

In the above-described embodiment, the display control unit 62 performs the control of displaying the screens of the first screen, the second screen, and the third screen on the second display unit 26, but the disclosed technology is not limited to this embodiment. The display control unit 62 may perform control for displaying each screen on the first display unit 24, or may perform control for displaying each screen on the first display unit 24 and the second display unit 26.

Further, a process performed by CPU reading the software (program) in the above-described embodiment may be performed by various processors other than CPU. Examples of the processor include a PLD (Programmable Logic Device) that can change the circuitry after manufacturing such as FPGA (Field-Programmable Gate Array). Examples of the processor include a dedicated electric circuit that is a processor having a circuit configuration specifically designed for performing a particular process such as ASIC (Application Specific Integrated Circuit). Further, the respective processes may be performed by one of the various processors, or may be performed by a combination of two or more processors (for example, a plurality of FPGA, a combination of CPU and FPGA, and the like) of the same type or a different type. Further, a hardware structure of the various processors is, more specifically, an electric circuit in which circuit elements such as semiconductor elements are combined.

Further, in the above-described embodiment, various types of data are stored in ROM or the storage, but the present disclosure is not limited thereto. For example, recording media such as CD (Compact Disk), DVD (Digital Versatile Disk), and USB (Universal Serial Bus) memories may be used as the storage unit. In this case, various programs, data, and the like will be stored in these recording media.

Further, the program of the present disclosure can be provided as a program product. A program product includes any aspect of a product for providing a program. For example, the program product includes a program provided through a network such as the Internet, a non-transitory computer-readable recording medium such as a CD-ROM, DVD storing the program, and the like.

Although the vehicle 12 according to the embodiment has been described above, it is needless to say that the vehicle can be implemented in various forms without departing from the gist of the present disclosure.

What is claimed is:

1. A display control device comprising a display control unit configured to:
when a crawl control function provided in a vehicle is turned from a non-operating state to an operating state, control a display unit so as to display a second screen for a predetermined period, the second screen transitioning from a first screen and indicating that the crawl control function is turned to the operating state; and
control the display unit so as to additionally display a set speed of the vehicle set by the crawl control function on the first screen after display of the second screen is finished.

2. The display control device according to claim 1, wherein the display control unit is configured to:
when the crawl control function is turned from the non-operating state to the operating state, control the display unit so as to display the second screen by superimposing a display layer of the set speed of the vehicle set by the crawl control function and a display layer of the second screen on a display layer of the first screen; and
control the display unit so as to additionally display the set speed of the vehicle set by the crawl control function on the first screen by deleting the display layer of the second screen after the predetermined period has elapsed since control for displaying the second screen is performed.

3. The display control device according to claim 2, wherein the display control unit deletes the display layer of the set speed of the vehicle set by the crawl control function when an input of a switch operation to turn the crawl control function to the non-operating state is received.

4. A non-transitory storage medium storing a display control program causing a computer to execute a process comprising:
when a crawl control function provided in a vehicle is turned from a non-operating state to an operating state, controlling a display unit so as to display a second screen for a predetermined period, the second screen transitioning from a first screen and indicating that the crawl control function is turned to the operating state; and
controlling the display unit so as to additionally display a set speed of the vehicle set by the crawl control function on the first screen after display of the second screen is finished.
